(19) United States
(12) Patent Application Publication
(10) Pub. No.: US 2014/0280115 A1
(43) Pub. Date: Sep. 18, 2014

(54) METHODS, APPARATUSES, AND COMPUTER PROGRAM PRODUCTS FOR IMPROVED DEVICE AND NETWORK SEARCHING

(71) Applicant: NOKIA CORPORATION, Espoo (FI)

(72) Inventor: Richard Collin, Saratoga, CA (US)

(73) Assignee: NOKIA CORPORATION, Espoo (FI)

(21) Appl. No.: 13/827,873

(22) Filed: Mar. 14, 2013

(51) Int. Cl. G06F 17/30

(52) U.S. Cl. CPC G06F 17/30522
USPC 707/731

(57) ABSTRACT

Methods, apparatuses, and computer program products are herein provided for improved device and network searching based on the number of character inputs being provided. A method may include receiving at least one character input. The method may further include causing, in response to receiving the at least one character input, performance of a first search within a local memory of a device based at least in part on the at least one character input. The method may further include causing, in response to receiving a number of character inputs that exceeds a threshold number, performance of a second search external to the device based at least in part on the character inputs. Corresponding apparatuses and computer program products are also provided.

### TECHNOLOGICAL FIELD

An example embodiment of the present invention relates generally to user interface technology and, more particularly, relates to methods, apparatuses, and computer program products for improved device and network searching based on the number of character inputs being provided.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

With increased functionality, mobile computing devices can be used to perform a variety of functions. For example, some mobile computing devices may be configured to perform searches for a user.

### BRIEF SUMMARY

Due to the increased functionality, however, the scope of the search can be massive, often leading to overwhelming results. Indeed, a search may be performed within the local memory of the mobile computing device and external to the mobile computing device (such as over a network). Such a search may provide results that are not tailored to what the user is looking for.

As such, some embodiments of the present invention provide for improved device and network searching. In some embodiments, a dynamic search function may be provided that allows a user to quickly search within the local memory of a device or external to the device. Indeed, the search may start out as a local memory search, and only add an external search once a certain number of character inputs have been provided. In such a manner, if the user is looking for something stored within the local memory of the device, the user will be provided with more relevant search results with a need for only limited input. Thus, unnecessary external search results will be filtered out.

In one example embodiment, a method includes receiving at least one character input. The method further includes causing, in response to receiving the at least one character input, performance of a first search within a local memory of a device based at least in part on the at least one character input. The method further includes causing, in response to receiving a number of character inputs that exceeds a threshold number, performance of a second search external to the device based at least in part on the character inputs. In some embodiments, the threshold number of character inputs is two character inputs.

In some embodiments, the method may include causing performance of the first search by causing performance of the first search among a list of tasks, contacts, and/or subjects of tasks that are commonly-used by a user. Additionally, in some embodiments, the method may further include determining the list of tasks, contacts, and/or subjects of tasks based on historical interaction between the user and the device.

In some embodiments, the method may include causing performance of the second search external to the device by causing performance of the second search within a network.

In some embodiments, the method may further include causing presentation of at least one result of the first search to a user. In some embodiments, the method may further include causing presentation of at least one result of the second search to a user.

In some embodiments, the method may include receiving the at least one character input by receiving at least one character input gesture from a user, wherein the at least one character input gesture is associated with at least one letter.

In some embodiments, the method may include causing performance of the second search by causing performance of the first search and performance of the second search based on the character inputs. Additionally, in some embodiments, the method may further include causing presentation of at least one result of the first search and the second search.

In another example embodiment, an apparatus comprises at least one processor and at least one memory storing computer program code with the at least one memory and stored computer program code being configured, with the at least one processor, to cause the apparatus to receive at least one character input. The at least one memory and stored computer program code are configured, with the at least one processor, to further cause the apparatus to cause, in response to receiving the at least one character input, performance of a first search within a local memory of a device based at least in part on the at least one character input. The at least one memory and stored computer program code are configured, with the at least one processor, to further cause the apparatus to cause, in response to receiving a number of character inputs that exceeds a threshold number, performance of a second search external to the device based at least in part on the character inputs.

In another example embodiment, a computer program product is provided. The computer program product of this example embodiment includes at least one computer-readable storage medium having computer-readable program instructions stored therein. The program instructions of this example embodiment comprise program instructions configured to cause an apparatus to perform a method including receiving at least one character input. The method further includes causing, in response to receiving the at least one character input, performance of a first search within a local memory of a device based at least in part on the at least one character input. The method further includes causing, in response to receiving a number of character inputs that exceeds a threshold number, performance of a second search external to the device based at least in part on the character inputs.

In another example embodiment, an apparatus is provided. The apparatus comprises means for receiving at least one character input. The apparatus further comprises means for causing, in response to receiving the at least one character input, performance of a first search within a local memory of a device based at least in part on the at least one character input. The apparatus further comprises means for causing, in response to receiving a number of character inputs that exceeds a threshold number, performance of a second search external to the device based at least in part on the character inputs.

### BRIEF DESCRIPTION OF THE DRAWINGS

Having thus described some embodiments of the invention in general terms, reference will now be made to the accompanying drawings, which are not necessarily drawn to scale, and wherein:

FIG. 1 illustrates a block diagram of an apparatus according to an example embodiment of the present invention;

FIG. 2 is a schematic block diagram of a mobile terminal according to an example embodiment of the present invention;

FIG. 3 illustrates an example apparatus, such as the apparatus shown in FIG. 1, wherein a user is providing input indicating a character input for a search function, in accordance with an example embodiment of the present invention described herein;

FIG. 4 illustrates the apparatus shown in FIG. 3, wherein the apparatus is conducting a search through a network, in accordance with an example embodiment of the present invention described herein;

FIG. 5 illustrates the apparatus shown in FIG. 3, wherein results of a search within a local memory of the apparatus are presented, in accordance with an example embodiment of the present invention described herein;

FIG. 6 illustrates the apparatus shown in FIG. 5, wherein the user has provided a second character input and the search results have been updated accordingly, in accordance with an example embodiment of the present invention described herein;

FIG. 7 illustrates the apparatus shown in FIG. 6, wherein the user has provided a third character input and the apparatus has performed a search through a network and the search results have been updated accordingly, in accordance with an example embodiment of the present invention described herein;

FIG. 8 illustrates a flowchart according to an example method for improved device and network searching based on the number of character inputs being provided, in accordance with an example embodiment of the present invention described herein; and

FIG. 9 illustrates a flowchart according to another example method for improved device and network searching based on the number of character inputs being provided, in accordance with an example embodiment of the present invention described herein.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to singular or plural data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

FIG. 1 illustrates a block diagram of an apparatus 102 configured for improved device and network searching based on the number of character inputs being provided according to an example embodiment. It will be appreciated that the apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for performing operations and operational routing, other configurations may also be used to implement embodiments of the present invention.

The apparatus 102 may be embodied as either a fixed device or a mobile device such as a desktop computer, laptop computer, mobile terminal, mobile computer, mobile phone, mobile communication device, game device, digital camera/camcorder, audio/video player, television device, radio receiver, digital video recorder, positioning device, a chipset, a computing device comprising a chipset, any combination thereof, and/or the like. In this regard, the apparatus 102 may comprise any computing device that comprises or is in operative communication with a user interface (e.g., a touch display capable of displaying a graphical user interface). In some example embodiments, the apparatus 102 is embodied as a mobile computing device, such as the mobile terminal illustrated in FIG. 2.

In this regard, FIG. 2 illustrates a block diagram of a mobile terminal 10 representative of one example embodiment of an apparatus 102. It should be understood, however, that the mobile terminal 10 illustrated and hereinafter described is merely illustrative of one type of apparatus 102 that may implement and/or benefit from various example embodiments of the invention and, therefore, should not be taken to limit the scope of the disclosure. While several embodiments of the electronic device are illustrated and will be hereinafter described for purposes of example, other types of electronic devices, such as mobile telephones, mobile computers, personal digital assistants (PDAs), pagers, laptop computers, desktop computers, gaming devices, positioning devices, tablet computers, televisions, e-papers, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of communicating according to Wi-Fi, Near Field Communications (NFC), BlueTooth, Worldwide Interoperability for Microwave Access (WiMAX) or other proximity-based communications protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The display 28 may, for example, comprise a three-dimensional touch display, examples of which will be described further herein below. The user input interface may comprise devices allowing the mobile terminal to receive data, such as a keypad 30, a touch display (e.g., some example embodiments wherein the display 28 is configured as a touch display), a joystick (not shown), sensor 18, and/or other input device. In embodiments including a keypad, the keypad may comprise numeric (0-9) and related keys (#, *), and/or other keys for operating the mobile terminal 10. Alternatively or additionally, the keypad 30 may include a conventional QWERTY keypad arrangement.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the apparatus 102 includes various means for performing the various functions herein described. These means may comprise one or more of a processor 110, memory 112, communication interface 114, user interface 116, sensor 118, or user interface (UI) control circuitry 122. The means of the apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

In some example embodiments, one or more of the means illustrated in FIG. 1 may be embodied as a chip or chip set. In other words, the apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, sensor 118, and/or UI control circuitry 122 may be embodied as a chip or chip set. The apparatus 102 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, one or more other types of hardware processors, or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In embodiments wherein the apparatus 102 is embodied as a mobile terminal 10, the processor 110 may be embodied as or comprise the processor 20 (shown in FIG. 2). In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 102 is embodied as a mobile terminal 10, the memory 112 may comprise the volatile memory 40 and/or the non-volatile memory 42 (shown in FIG. 2). The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. The stored information may include, for example, images, content, media content, user data, application data, and/or the like. This stored information may be stored and/or used by the UI control circuitry 122 during the course of performing its functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In some example embodiments, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. In embodiments wherein the apparatus 102 is embodied as a mobile terminal 10, the communication interface 114 may be embodied as or comprise the transmitter 14 and receiver 16 (shown in FIG. 2). The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 102 and one or more computing devices may be in communication. As an example, the communication interface 114 may be configured to receive and/or otherwise access content (e.g., web page content, streaming media content, and/or the like) over a network from a server or other content source. Additionally or alternatively, the communication interface 114 may be configured to support communications in accordance with any proximity-based protocol including, for example, Wi-Fi, NFC, BlueTooth, WiMAX or the like. The communication interface 114 may additionally be in communication with the memory 112, user interface 116, and/or UI control circuitry 122, such as via a bus.

The sensor 118 may be in communication with the processor 110 and/or UI control circuitry 122. The sensor 118 may be configured to sense and/or detect input. Additionally, in some embodiments, the sensor 118 may be configured to detect or sense at least one character input gesture. For example, the sensor 118 may detect movement of a user's finger that indicates at least one character input gesture. In such a manner, the sensor 118 may be configured to provide output indicative of the character input gesture to the apparatus 102 (e.g., the processor 110). In embodiments wherein the apparatus 102 is embodied as a mobile terminal 10, the sensor 118 may be embodied as or comprise the sensor 18 (shown in FIG. 2). In some embodiments, the processor 110 and/or UI control circuitry 122 may be configured to receive input from the sensor 118 and determine at least one character (e.g., letter) associated with the character input gesture. In some embodiments, the sensor 118 may comprise at least one of a pressure sensor, a proximity sensor, a light sensor, an accelerometer, or a gyroscope.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touchscreen display, a microphone, a speaker, and/or other input/output mechanisms. In some embodiments, a display may refer to display on a screen, on a wall, on glasses (e.g., near-eye-display), in the air, etc. In embodiments wherein the apparatus 102 is embodied as a mobile terminal 10, the user interface 116 may be embodied as or comprise the display 28 and keypad 30 (shown in FIG. 2). The user interface 116 may be in communication with the memory 112, communication interface 114, and/or UI control circuitry 122, such as via a bus.

The UI control circuitry 122 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In some example embodiments wherein the UI control circuitry 122 is embodied separately from the processor 110, the UI control circuitry 122 may be in communication with the processor 110. The UI control circuitry 122 may further be in communication with one or more of the memory 112, communication interface 114, or user interface 116, such as via a bus.

The UI control circuitry 122 may be configured to receive user input from a user interface 116, such as a touch display (e.g., touchscreen). The user input or signal may carry positional information indicative of the user input. In this regard, the position may comprise a position of the user input in a two-dimensional space, which may be relative to the surface of the touch display user interface. For example, the position may comprise a coordinate position relative to a two-dimensional coordinate system (e.g., an X and Y axis), such that the position may be determined. Accordingly, the UI control circuitry 122 may determine a position of the user input such as for determining a portion of the display to which the user input correlates.

The touch display may also be configured to enable the detection of a hovering gesture input. A hovering gesture input may comprise a gesture input to the touch display without making physical contact with a surface of the touch display, such as a gesture made in a space some distance above/in front of the surface of the touch display. As an example, the touch display may comprise a capacitive touch display, which may be configured to enable detection of capacitance of a finger or other input object by which a gesture may be made without physically contacting a display surface. As another example, the touch display may be configured to enable detection of a hovering gesture input through use of acoustic wave touch sensor technology, electromagnetic touch sensing technology, near field imaging technology, optical sensing technology, infrared proximity sensing technology, some combination thereof, or the like.

In some embodiments, the apparatus 102, such as through the user interface 116, UI control circuitry 122, and/or sensor 118, may be configured to receive an indication that the apparatus should perform a search. In some embodiments, the apparatus 102 may be configured to receive user input and, in response, cause performance of a search function. For example, with reference to FIG. 3, the user 205 may have provided an indication to the apparatus 200 that the apparatus should perform a search. In response, the apparatus 200 may display a search function 222 on a screen 208.

In some embodiments, the apparatus 102, such as through the user interface 116, UI control circuitry 122, and/or sensor 118, may be configured to receive at least one character input. For example, with reference to FIG. 3, the apparatus 200 may display a virtual keyboard 209 that enables the user to enter at least one character input into the input box 220. In the depicted embodiment, the user 205 has selected the letter “P” 221 with their finger 207. In response, the letter “P” 231 has been displayed in the input box 220.

Though the above described embodiment details indicating a character input in the form of selecting a character from a virtual keyboard, some embodiments of the present invention contemplate other forms of user input to indicate at least one character input. In some embodiments, the apparatus 102, such as through the sensor 118, user interface 116, and/or UI control circuitry 122, may be configured to receive at least one character input gesture from a user. The character input gesture may be associated with at least one character (e.g., a letter, a number, etc.). For example, a user may sweep two fingers across a surface of the apparatus, such as the front surface. The apparatus may recognize the gesture as a character input gesture and may further determine that the performed gesture is associated with the letter “P”. In such a regard, in response, the apparatus may determine to input the letter “P” into the search function.

As noted herein, in some embodiments, the apparatus 102 may be configured to cause performance of a search. The search may be used to cull through information to locate something and may be any type of search relevant to the user and/or apparatus. For example, the search may be used to find a task the user wishes to perform, find contacts of the user, find subjects of desired tasks, find information related to the search subject, find applications, etc.

In such a regard, in some embodiments, the apparatus 102, such as through the processor 110 and/or memory 112, may be configured to cause performance of a search within a local memory of the apparatus. In some embodiments, the apparatus 102, such as through the processor 110 and/or memory 112, may be configured to cause performance of a search among a list of tasks, contacts, and/or subjects of tasks that are stored in the local memory. For example, the apparatus 200 may have the capability to perform a number of tasks (e.g., call a contact, play music, take a picture) using various applications. Such tasks may be just some of the tasks the apparatus 200 may have the capability to perform. As such, when causing performance of a search within the local memory of the apparatus, the search may be conducted from a database (or list) that includes at least these tasks.

Though the above described example details a search through tasks listed within a local memory, as noted above, some embodiments of the present invention contemplate a search within a local memory that encompasses other subjects (e.g., contacts of the user, subjects of tasks, information related to the search subject, applications stored in the local memory, etc.).

Additionally or alternatively, in some embodiments, the apparatus 102, such as through the processor 110 and/or communication interface 114, may be configured to perform a search external to the apparatus. In some embodiments, the apparatus 102, such as through the processor 110 and/or memory 112, may be configured to cause performance of a search within a network. For example, with reference to FIG. 4, the apparatus 200 may cause performance of a search through the network 250. In such a regard, the apparatus 200 may send signals 251 to and receive signals 251 from the network 250 to search among information on the network (e.g., perform an internet search, perform a search through a remote database, perform a search of information stored in a cloud service, etc.).

In some cases, the apparatus 102 may cause performance of a search that is both within the local memory and external to the apparatus. Along these lines, because there are so many different databases to search within, the search results can often become overwhelming to the user. Moreover, it may be difficult to properly define the scope of the search to limit the search results. Indeed, in some cases, a user may want to quickly search for a task on the local apparatus (e.g., send an email). However, in other cases, the user may wish to search external to the apparatus, such as over the internet.

As such, some embodiments of the present invention provide for improved device and network searching. In some embodiments, a dynamic search function is provided that allows a user to quickly search within the local memory of the device (e.g., apparatus 102) or external to the device. Moreover, the apparatus may switch between the local memory search and the external search based on the number of character inputs the user provides. In such a manner, the user may be provided with more relevant search results and may be able to dictate the scope of the search.

In some embodiments, the apparatus 102, such as through the processor 110 and/or memory 112, may be configured to, in response to receiving at least one character input, cause performance of a first search within a local memory of a device (e.g., the apparatus 102). In some embodiments, the first search may be performed based at least in part on the at least one character input. In some embodiments, the apparatus 102, such as through the processor 110 and/or memory 122, may be configured to cause performance of the first search from among a list of tasks, contacts, subjects of tasks, and/or applications that are stored within the local memory of the device (e.g., apparatus 102). The task may be a particular action or function to perform (e.g., call, send, play, etc.) The contacts may be contact information of other users that the user has saved in the memory. The subject of a task may be any subject related to a task that the apparatus can execute. For example, a destination recently searched for in a Map application may be a subject of a task. Similarly, a song recently played by the Music application may be another example of a subject of a task. The application may be an application stored in the local memory (e.g., a social networking application, a media player application, a productivity application, etc.)

FIG. 5 illustrates an example search being performed within the local memory of the apparatus 300. In the depicted embodiment, the apparatus 300 has launched a search function 312 that includes an input box 320. Additionally, the apparatus 200 may display a virtual keyboard 309 that enables the user to enter at least one character input into the input box 320. In the depicted embodiment, the user 305 has selected the letter “P” 321 with their finger 307. In response, the letter “P” 331 has been displayed in the input box 320. In response to receiving the indication of the character input 321 of “P”, the apparatus 300 may cause performance of a first search within the local memory based on the letter “P”. For example, the apparatus 300 may cause performance of the search from among a list of tasks, contacts, applications and/or subjects of tasks for results that start with the letter “P”.

In some embodiments, the apparatus 102, such as through the processor 110 and/or user interface 116, may be configured to cause presentation of at least one result of the first search to the user. Additionally, in some embodiments, the apparatus 102 may be configured cause presentation of the search results in a predetermined order (e.g., based on relevance, based on when the last task was used, alphabetically, etc.). For example, with reference to FIG. 5, the apparatus 300 may cause presentation of at least some of the search results on the screen 308. In the depicted embodiment, the search results are presented under the input box 320. As such, since the letter “P” was the first character input in the search, the results of Phone 371a, Photos 371b, Play . . . 371c, Post Office 371d, and Potter 371e are presented to the user as results (e.g., all the results start with the letter “P”). In such an example, Play . . . may be a task that is stored within a list of available tasks within the local memory of the device (e.g., the apparatus 300). The Phone application and the Photos application may be applications that are stored within the local memory of the device (e.g., the apparatus 300). Along these lines, the Post Office may be a recent destination for the Map application that is stored within the local memory of the device. Further, Potter may be a contact that is stored within the local memory of the device.

In some embodiments, the apparatus 102, such as through the processor 110 and/or memory 122, may be configured to cause performance of the first search to be limited among a list, such as a list of tasks, contacts, applications and/or subjects of tasks that are commonly-used by a user. Additionally, the apparatus 102, such as through the processor 110 and/or memory 122, may be configured to determine the list of tasks, contacts, applications and/or subjects of tasks based on historical interaction between the user and the device. For example, the list may include all tasks, contacts, and subjects of tasks that have been used by the user of the device within a predetermined period of time (e.g., the last day, the last week, etc.). In another example embodiment, the list may include a certain number of tasks, contacts, applications and subjects of tasks that have been most recently used by the user of the device (e.g., the last ten, the fifty, etc.). In another example embodiment, the list may be determined based on current context (such as location or time of day). In such a manner, some embodiments of the present invention may provide a tailored search that will provide quick and relevant search results.

Some embodiments of the present invention may provide for enabling a second search external to the device once a threshold number of character inputs have been received. In some embodiments, the apparatus 102, such as through the processor 110 and/or communication interface 114, may be configured to, in response to receiving a number of character inputs that exceeds a threshold number, cause performance of a second search external to the device. In some embodiments, the second search may be based at least in part on the character inputs. In some embodiments, the apparatus 102, such as through the processor 110 and/or communication interface 114, may be configured to cause performance of the second search within a network. Additionally, in some embodiments, the apparatus 102, such as through the processor 110 and/or user interface 116, may be configured to cause presentation of at least one result of the second search to the user.

For example, with reference to FIG. 6, the user 305 has entered another character input 322 of the letter “H”. As such, the letter “h” has been presented within the input box 320 adjacent to the letter “P” such that the input box 320 now contains the two character inputs of “Ph”. However, in the depicted embodiment, the threshold number of character inputs to cause performance of a second search external to the device may be “2” and, thus, the apparatus 300 has not yet caused performance of the second search. As such, the apparatus 300 has updated the first search within the local memory to remove tasks, contacts, applications and subjects of tasks that do not start with a “Ph” (e.g., the results of “Play . . . ”, “Post Office”, and “Potter” shown in FIG. 5 have been removed). As such, the results now comprise a “Phone” application 372a and a “Photos” application 372b.

However, with reference to FIG. 7, once the user 305 enters the third character input 323 of the letter “O”, the threshold number of character inputs has been exceeded. As such, the apparatus 300 causes performance of the second search external to the apparatus 300. In the depicted embodiment, the apparatus 300 has caused performance of a search within the network 350 (such as through signals 399). As shown in the input box 320, the character inputs define “Pho”. Thus, the apparatus 300 has now presented new search results from both within the local memory and within the external network. As such, the results now comprise “Pho” 373a, a “Phone” application 373b, “Phonograph” 373c, and a “Photos” application 373d. “Pho” and “Phonograph” may be results from an internet search, while the “Phone” application and the “Photos” application may be results of the first search within the local memory.

Though the above described embodiment with respect to FIG. 7 details search results from a combination of the first search within the local memory of the device and the second search external to the device, some embodiments of the present invention contemplate only performing a second search external to the device when the number of character inputs exceeds the threshold number. Along these lines, in such an embodiment of causing performance of only the search external to the device, the results of the “Phone” application 373b and the “Photos” application 373d may not have been presented in FIG. 7.

Additionally, though the above described embodiment details a threshold number of character inputs as two character inputs, any number of may be used (e.g., 3, 1, 4, etc.).

Some embodiments of the present invention provide a number of advantages. For example, a dynamic search that is based on the number of character inputs provides a single interaction pattern that enables a user to better control the scope of the search. Further, by basing the type of search on the number of character inputs, the user can receive relevant responses at a good speed and save battery life when wanting to perform searches that are local to the device.

Along these lines, some embodiments of the present invention are intuitive and align with the scope of the respective searches. For example, a search within a local memory of a device is likely to have a smaller scope than that of a search external to the device (e.g., the local search will be culling through less candidates). Thus, use of less character inputs to help determine the desired result is needed for a search within a local memory of a device. Said differently, there are far less candidates within the local memory of the device that start with the letters “Ph” than candidates from an external search. As such, using less character inputs for a local memory search aligns with the scope of the local memory search. Likewise, due to the increased number of available candidates in an external search, more character inputs will likely be needed to properly narrow the results. As such, using more character inputs for an external search aligns with the scope of the external search.

Embodiments of the present invention provide methods, apparatus and computer program products for improved device and network searching based on the number of character inputs being provided. Various examples of the operations performed in accordance with embodiments of the present invention will now be provided with reference to FIGS. 8-9.

FIG. 8 illustrates a flowchart according to an example method for improved device and network searching based on the number of character inputs being provided according to an example embodiment 400. The operations illustrated in and described with respect to FIG. 8 may, for example, be performed by, with the assistance of, and/or under the control of one or more of the processor 110, memory 112, communication interface 114, user interface 116, sensor 118, or UI control circuitry 122. Operation 402 may comprise receiving at least one character input. The processor 110, user interface 116, sensor 118, and/or UI control circuitry 122 may, for example, provide means for performing operation 402. Operation 404 may comprise causing, in response to receiving the at least one character input, performance of a first search within a local memory of a device based at least in part on the at least one character input. The processor 110 and/or memory 112 may, for example, provide means for performing operation 404. Operation 406 may comprise causing, in response to receiving a number of character inputs that exceeds a threshold number, performance of a second search external to the device based at least in part on the character inputs. The processor 110 and/or communication interface 114 may, for example, provide means for performing operation 406.

FIG. 9 illustrates a flowchart according to another example method for improved device and network searching based on the number of character inputs being provided according to an example embodiment 500. The operations illustrated in and described with respect to FIG. 9 may, for example, be performed by, with the assistance of, and/or under the control of one or more of the processor 110, memory 112, communication interface 114, user interface 116, sensor 118, or UI control circuitry 122. Operation 502 may comprise receiving at least one character input. The processor 110, user interface 116, sensor 118, and/or UI control circuitry 122 may, for example, provide means for performing operation 502. Operation 504 may comprise causing, in response to receiving the at least one character input, performance of a first search within a local memory of a device based at least in part on the at least one character input. The processor 110 and/or memory 112 may, for example, provide means for performing operation 504. In some embodiments, operation 505 may comprise causing presentation of at least one results of the first search to the user. The processor 110, user interface 116, and/or UI control circuitry 122 may, for example, provide means for performing operation 505.

Operation 506 may comprise causing, in response to receiving a number of character inputs that exceeds a threshold number, performance of a second search external to the device based at least in part on the character inputs. The processor 110 and/or communication interface 114 may, for example, provide means for performing operation 506. In some embodiments, operation 507 may comprise causing presentation of at least one results of the second search to the user. The processor 110, user interface 116, and/or UI control circuitry 122 may, for example, provide means for performing operation 507.

FIGS. 8-9 illustrate flowcharts of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 110) may provide all or a portion of the elements. In another embodiment, all or a portion of the elements may be configured by and operate under control of a computer program product. The computer program product for performing the methods of an example embodiment of the invention includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
receiving at least one character input;
causing, by a processor, in response to receiving the at least one character input, performance of a first search within a local memory of a device based at least in part on the at least one character input; and
causing, in response to receiving a number of character inputs that exceeds a threshold number, performance of a second search external to the device based at least in part on the character inputs.

2. The method according to claim 1, wherein causing performance of the first search comprises causing performance of the first search among a list of tasks, contacts, and/or subjects of tasks that are commonly-used by a user.

3. The method according to claim 2 further comprising determining the list of tasks, contacts, and/or subjects of tasks based on historical interaction between the user and the device.

4. The method according to claim 1, wherein causing performance of the second search external to the device comprises causing performance of the second search within a network.

5. The method according to claim 1, wherein the threshold number of character inputs is two character inputs.

6. The method according to claim 1 further comprising causing presentation of at least one result of the first search to a user.

7. The method according to claim 1 further comprising causing presentation of at least one result of the second search to a user.

8. The method according to claim 1, wherein receiving the at least one character input comprises receiving at least one character input gesture from a user, wherein the at least one character input gesture is associated with at least one letter.

9. The method according to claim 1, wherein causing performance of the second search comprises causing performance of the first search and performance of the second search based on the character inputs.

10. The method according to claim 9 further comprising causing presentation of at least one result of the first search and the second search.

11. An apparatus comprising a processor and a memory including computer program code, the memory and the computer program code configured to, with the processor, cause the apparatus to:
receive at least one character input;
cause, in response to receiving the at least one character input, performance of a first search within a local memory of a device based at least in part on the at least one character input; and
cause, in response to receiving a number of character inputs that exceeds a threshold number, performance of a second search external to the device based at least in part on the character inputs.

12. The apparatus of claim 11, wherein the memory and the computer program code are further configured to, with the processor, cause the apparatus to cause performance of the first search by causing performance of the first search among a list of tasks, contacts, and/or subjects of tasks that are commonly-used by a user.

13. The apparatus of claim 12, wherein the memory and the computer program code are further configured to, with the processor, cause the apparatus to determine the list of tasks, contacts, and/or subjects of tasks based on historical interaction between the user and the device.

14. The apparatus of claim 11, wherein the memory and the computer program code are further configured to, with the processor, cause the apparatus to cause performance of the second search external to the device by causing performance of the second search within a network.

15. The apparatus of claim 11, wherein the threshold number of character inputs is two character inputs.

16. The apparatus of claim 11, wherein the memory and the computer program code are further configured to, with the processor, cause the apparatus to receive the at least one character input by receiving at least one character input gesture from a user, wherein the at least one character input gesture is associated with at least one letter.

17. The apparatus of claim 11, wherein the memory and the computer program code are further configured to, with the processor, cause the apparatus to cause performance of the second search by causing performance of the first search and performance of the second search based on the character inputs.

18. The apparatus of claim 17, wherein the memory and the computer program code are further configured to, with the processor, cause the apparatus to cause presentation of at least one result of the first search and the second search.

19. Computer program product comprising a non-transitory computer readable medium having program code portions stored thereon, the program code portions being a computer readable medium and configured when said program product is run on a computer or network device, to:
receive at least one character input;
cause, in response to receiving the at least one character input, performance of a first search within a local memory of a device based at least in part on the at least one character input; and
cause, in response to receiving a number of character inputs that exceeds a threshold number, performance of a second search external to the device based at least in part on the character inputs.

20. The computer program product of claim 19, wherein the program code portions are further configured, when said program product is run on a computer or network device, to cause performance of the first search by causing performance of the first search among a list of tasks, contacts, and/or subjects of tasks that are commonly-used by a user.
